(19) United States
(12) Patent Application Publication
(10) Pub. No.: US 2009/0261062 A1
(43) Pub. Date: Oct. 22, 2009

(54) CARRIER SUBSTRATE AND METHOD OF MANUFACTURING FLEXIBLE DISPLAY APPARATUS USING THE SAME

(76) Inventor: Myung-Hwan Kim, Yongin-si (KR)

Correspondence Address: Haynes and Boone, LLP;IP Section, 2323 Victory Avenue, SUITE 700, Dallas, TX, 75219, US

(21) Appl. No.: 12/358,178

(22) Filed: Jan. 22, 2009

(30) Foreign Application Priority Data
Apr. 17, 2008 (KR) 2008-35700

(51) Int. Cl. C23F 1/00; B32B 33/00; B32B 5/00; B32B 5/18; B32B 38/10

(52) U.S. Cl. 216/24; 428/354; 428/336; 428/317.3; 156/247

(57) ABSTRACT

Disclosed are a carrier substrate which can be recycled and a method of manufacturing a flexible display apparatus using the same. The carrier substrate includes a rigid substrate, an adhesive layer, and a sacrificial layer. The adhesive layer is formed on the rigid substrate and has an adhesive property. The sacrificial layer is interposed between the rigid substrate and the adhesive layer. The sacrificial layer includes a material selected from the group consisting of a transparent metal oxide, an alkaline water-soluble polymer compound, and an acid water-soluble polymer compound.

### CROSS-REFERENCE TO RELATED APPLICATION

This application claims priority to Korean Patent Application No. 2008-35700 filed on Apr. 17, 2008, the contents of which are herein incorporated by reference in their entirety.

### BACKGROUND

1. Field of the Invention

The present invention relates to a carrier substrate used to manufacture a flexible display apparatus and a method of manufacturing a flexible display apparatus using the same.

2. Description of the Related Art

As information technologies are developed the demand for high-performance display apparatuses capable of displaying various types of information, such as videos, graphics, and characters to achieve high-speed transmission of the information has increased. According to such demands, the display industry has grown rapidly. Recently, flat panel displays (FPD) have been spotlighted because the FPDs can be fabricated in a large size with a slim and light structure.

Such an FPD includes a liquid crystal display (LCD), a plasma display panel (PDP), and an organic light emitting display (OLED). However, since the conventional LCD, PDP, and OLED employ a glass substrate having no flexibility, they have a limitation in applications and the use thereof.

Recently, a flexible display apparatus has been actively developed as a next generation display apparatus. The flexible display apparatus is foldable by employing a plastic substrate or a foil substrate having flexibility instead of a conventional glass substrate having no flexibility.

When manufacturing the FPD, a process of forming and handling thin film transistors on a plastic substrate (TFTs on plastic; TOP) is important. However, since the substrate of a flexible display apparatus has flexibility, many problems may occur when manufacturing a TOP panel by directly introducing the plastic substrate into the manufacturing process of a conventional glass substrate.

In order to utilize the conventional panel manufacturing process and equipment, an alternative method has been proposed. According to this method, after coating or bonding a plastic substrate on a carrier substrate such as a glass substrate, an array of thin film transistors is directly formed on the plastic substrate, and then the carrier substrate is separated from the plastic substrate.

However, when adopting the above method, many difficulties exist in development of an adhesive material that endures a high-temperature process and enables the carrier substrate to be easily separated from the plastic substrate after forming the array of the thin film transistors.

### SUMMARY

Therefore, an exemplary embodiment of the present invention provides a carrier substrate capable of being recycled and reducing a manufacturing cost.

Another exemplary embodiment of the present invention provides a method of manufacturing a flexible display apparatus using the carrier substrate.

In an exemplary embodiment of the present invention, a carrier substrate includes a rigid substrate, an adhesive layer, and a sacrificial layer. The adhesive layer is formed on the rigid substrate and has an adhesive property. The sacrificial layer is interposed between the rigid substrate and the adhesive layer. The sacrificial layer includes a material selected from the group consisting of a transparent metal oxide, an alkaline water-soluble polymer compound, and an acid water-soluble polymer compound.

The rigid substrate may include at least one glass material selected from the group consisting of E2K, borosilicate glass, fused silica glass, sapphire, and quartz.

The transparent metal oxide may include at least one selected from the group consisting of indium tin oxide, indium zinc oxide, and zinc oxide.

The alkaline water-soluble polymer compound may include at least one selected from the group consisting of polyacrylic acid, co-polymer containing polyacrylic acid, polystyrene, co-polymer containing polystyrene, polysulfate, co-polymer containing polysulfate, polyamic acid, and co-polymer containing polyamic acid.

The acid water-soluble polymer compound comprises at least one selected from the group consisting of polyamine, co-polymer containing polyamine, polyvinylalcohol (PVA), co-polymer containing PVA, polyallyamine, and polyacrylic acid.

The sacrificial layer may have a thickness of about 200 nm or less.

The adhesive layer may include polyimide or photoresist which is removed through irradiation of a laser beam.

The adhesive layer may have a thickness of about 20 nm to about 50 nm.

An etching promoter may be further provided on at least one surface of the sacrificial layer.

The etching promoter may include a porous material or a material enabling gelation and having a swelling property.

In another exemplary embodiment of the present invention, a method of manufacturing a flexible display apparatus is performed as follows.

A sacrificial layer is formed on a rigid substrate, and an adhesive layer is formed on the sacrificial layer to prepare a carrier substrate. A flexible substrate is laminated on the carrier substrate. A display layer and an opposite substrate are formed on the flexible substrate. The carrier substrate is delaminated by irradiating a laser beam on the adhesive layer. The sacrificial layer is removed.

The removal of the sacrificial layer may be achieved by an etchant.

The sacrificial layer may include a material selected from the group consisting of a transparent metal oxide, an alkaline water-soluble polymer compound, and an acid water-soluble polymer.

According to the above, the carrier substrate including the sacrificial layer and the adhesive layer may be recycled, thereby reducing a manufacturing cost.

### BRIEF DESCRIPTION OF THE DRAWINGS

The above and other advantages of the present invention will become readily apparent by reference to the following detailed description when considered in conjunction with the accompanying drawings wherein:

FIGS. 1A to 1C are sectional views showing a carrier substrate according to first to third embodiments of the present invention;

FIG. 2 is a flowchart illustrating a method of manufacturing a flexible display apparatus using a carrier substrate according to an exemplary embodiment of the present invention;

FIGS. 3A to 3H are sectional views showing a method of manufacturing an electrophoresis display apparatus as a method of manufacturing a flexible display apparatus according to a first embodiment of the present invention; and

FIGS. 4A and 4B are sectional views partially showing a method of manufacturing a flexible display apparatus according to a second embodiment of the present invention.

### DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

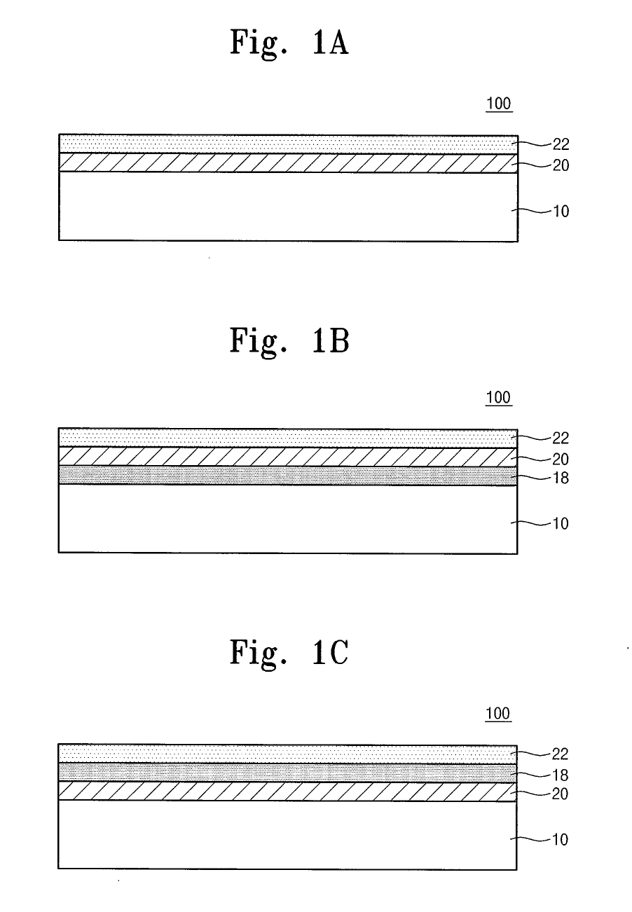

FIG. 1A is a sectional view showing a carrier substrate 100 according to a first embodiment of the present invention.

As shown in FIG. 1A, the carrier substrate 100 according to the first embodiment of the present invention includes a rigid substrate 10, an adhesive layer 22, and a sacrificial layer 20. The adhesive layer 22 is formed above the rigid substrate 10 and has an adhesive property. The sacrificial layer 20 is interposed between the rigid substrate 10 and the adhesive layer 22. The sacrificial layer 20 includes a material selected from the group consisting of a transparent metal oxide, an alkaline water-soluble polymer compound, and an acid water-soluble polymer compound.

The rigid substrate 10 may include a material allowing a laser beam to pass therethrough. For example, the rigid substrate 10 may include at least one selected from the group consisting of E2K, borosilicate glass, fused silica glass, sapphire, and quartz.

The sacrificial layer 20 may include a material selected from the group consisting of a transparent metal oxide, an alkaline water-soluble polymer compound, and an acid water-soluble polymer compound. The transparent metal oxide representatively includes indium tin oxide (ITO), indium zinc oxide (IZO), or zinc oxide (ZnO).

The alkaline water-soluble polymer compound is dissolved in an alkaline water solution to have a polymer chain with an anion. The alkaline water-soluble polymer compound representatively includes polyacrylic acid, co-polymer containing polyacrylic acid, polystyrene, co-polymer containing polystyrene, polysulfate, co-polymer containing polysulfate, polyamic acid, or co-polymer containing polyamic acid.

The acid water-soluble polymer compound is dissolved in an acid water solution to have a polymer chain with a cation. The acid water-soluble polymer compound representatively includes polyamine, co-polymer containing polyamine, polyvinylalcohol (PVA), co-polymer containing PVA, polyallyamine, or polyacrylic acid.

Such a sacrificial layer 20 allows a laser beam to pass therethrough, and may have a thickness of about 200 nm or less. If the thickness of the sacrificial layer 20 exceeds about 200 nm, the sacrificial layer 20 may remain without being delaminated by an irradiated laser beam to cause the failure of a display apparatus. In this regard, the sacrificial layer 20 preferably has the thickness of about 200 nm or less.

The adhesive layer 22 may include a polymer material such as polyimide or photoresist, which can be delaminated by a laser beam. Such an adhesive layer 22 preferably has a thickness of about 20 nm to about 50 nm. This range is determined by taking into consideration the function of the adhesive layer 22 that serves as an adhesive agent bonding the carrier substrate 100 to a flexible substrate and facilitating the delamination of the carrier substrate 100 after the display apparatus has been manufactured.

Conventionally, a flexible display apparatus is manufactured by directly bonding the rigid substrate 10 to the flexible substrate through the adhesive layer 22. However, when a laser beam is irradiated onto the adhesive layer 22 to delaminate the rigid substrate 10 from the flexible substrate, adhesive residues remain on the rigid substrate 10. In addition, even if a washing process is performed, the adhesive residues are not perfectly removed from the rigid substrate 10.

According to the present exemplary embodiment, the sacrificial layer 20 that can be removed by an etchant is interposed between the rigid substrate 10 and the adhesive layer 22. After delaminating the rigid substrate 10 by irradiating a laser beam onto the adhesive layer 22, adhesive residues existing on the sacrificial layer 20 are removed when the sacrificial layer 20 is removed from the rigid substrate 10 by the etchant, so that the rigid substrate 10 may be easily recycled.

FIG. 1B is a sectional view showing a carrier substrate 100 according to a second embodiment of the present invention.

As shown in FIG. 1B, the carrier substrate 100 according to the second embodiment of the present invention includes a rigid substrate 10, an adhesive layer 22, and a sacrificial layer 20, and further includes an etching promoter 18 provided under the sacrificial layer 20. The adhesive layer 22 is formed on the rigid substrate 10 and has an adhesive property. The sacrificial layer 20 is interposed between the rigid substrate 10 and the adhesive layer 22. The sacrificial layer 20 includes a material selected from the group consisting of a transparent metal oxide, an alkaline water-soluble polymer compound, and an acid water-soluble polymer compound. For the purpose of explanation, the same reference numerals will be assigned to the elements identical to those of the previous embodiment, and detailed description thereof will be omitted in order to avoid redundancy.

The etching promoter 18 may include a porous material or a polymer material enabling gelation and having a swelling property. However, in addition to the above material, if a predetermined material fast absorbs an etching solution (etchant), the material may be used for the etching promoter 18 without a specific condition. If the etching promoter 18 is porous, the size of an opening may be in the range of about 10 μm to about 1 nm. The etching promoter 18 may include an organic material such as a polymer compound, an in-organic material, and a mixture of an in-organic material and an organic material.

For example, the polymer material enabling gelation and having a swelling property may include polyethylene or polyvinylchioride (PVC). The etching promoter 18 employing the polymer material may be formed through a spin coating method, or a dropping method.

In addition, the porous material may include polyallyamine, polydiallyldiethyl ammonium chloride, polyacrylic acid, polyimide, polystyrene, or expandable urethane polymer. The etching promoter 18 employing the porous material may be formed through an electro-spinning scheme, a spin coating scheme, and a sintering scheme.

The etching promoter 18 smoothly removes the sacrificial layer 20 when the sacrificial layer 20 is removed through etching, so that the carrier substrate 100 can be recycled. The recycling of the carrier substrate 100 through the removal of the sacrificial layer 20 will be described in detail through the following method of manufacturing the flexible display apparatus.

Since the components and features according to the present embodiment are identical to those of the previous embodiment except for the etching promoter 18, details thereof will be omitted.

Although the etching promoter 18 is formed under the sacrificial layer 20 according to the present embodiment, the present invention is not limited thereto. For example, the etching promoter 18 may be formed on the sacrificial layer 20 as shown in FIG. 1C illustrating a carrier substrate 100 according to a third embodiment of the present invention.

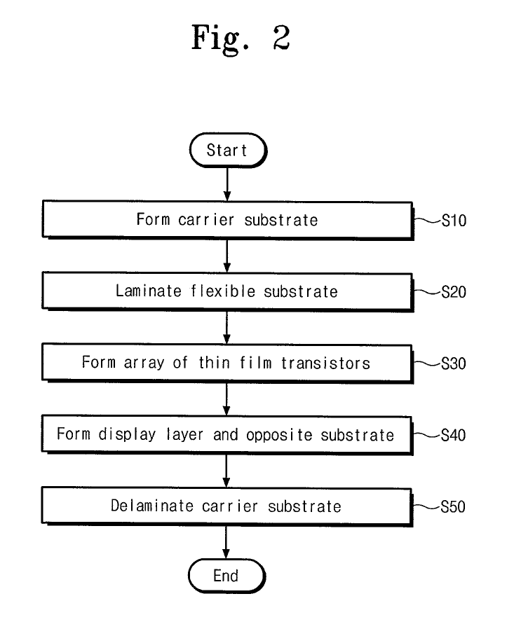

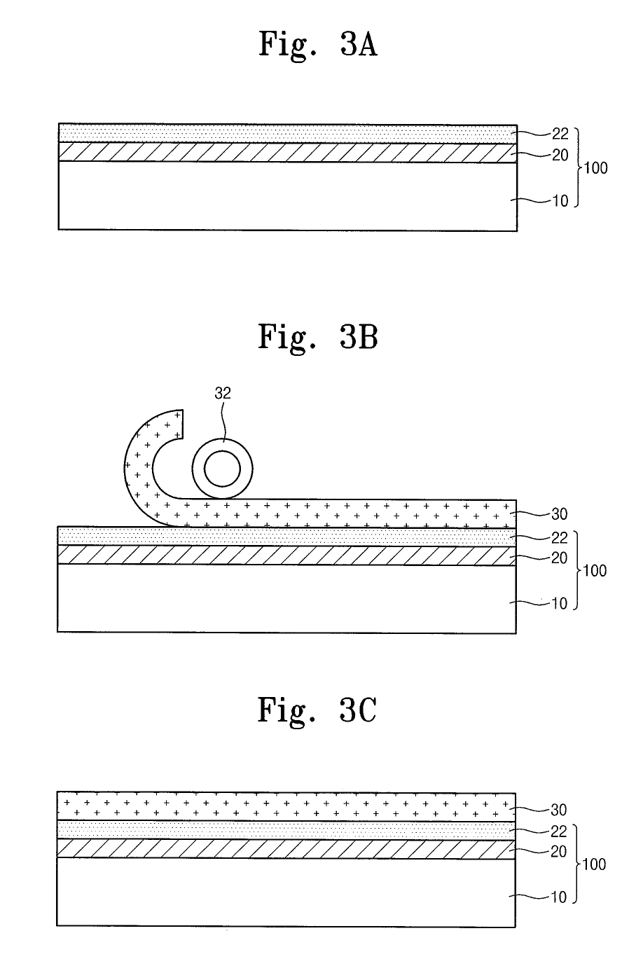

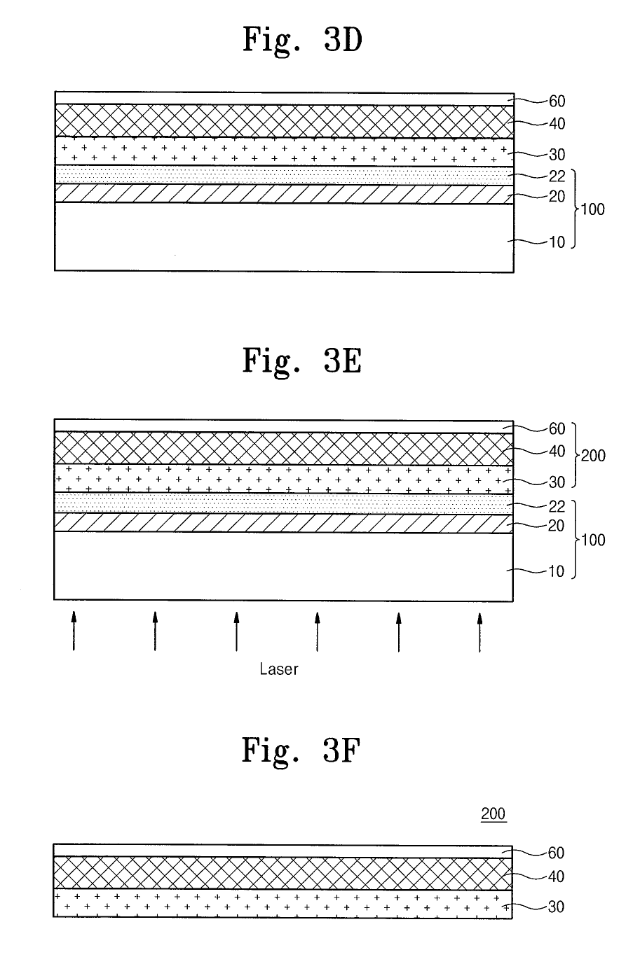

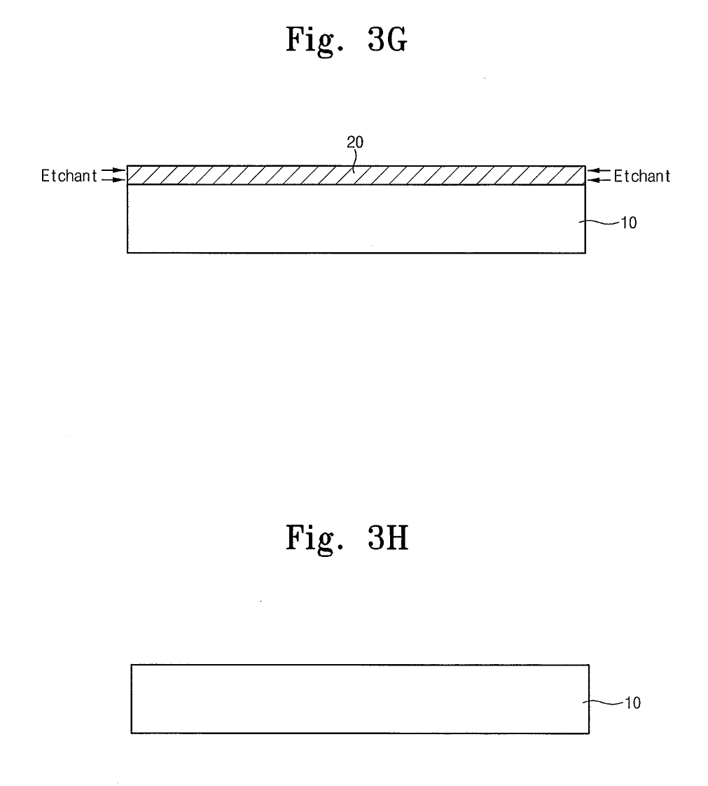

FIG. 2 is a flowchart illustrating the method of manufacturing the flexible display apparatus using the carrier substrate 100 according to an exemplary embodiment of the present invention, and FIGS. 3A to 3H are sectional views showing a method of manufacturing an electrophoresis display apparatus as the method of manufacturing the flexible display apparatus according to the first embodiment of the present invention.

Referring to FIG. 2, in the method of manufacturing the flexible display apparatus using the carrier substrate 100 according to an exemplary embodiment of the present invention, the carrier substrate 100 is formed (S10), a flexible substrate is laminated (S20), the array of thin film transistors is formed (S30), a display layer and an opposite substrate are formed (S40), and the carrier substrate is delaminated (S50).

Hereinafter, the method of manufacturing the electrophoresis display apparatus will be described in detail with reference to FIGS. 3A to 3H.

Referring to FIG. 3A, the adhesive layer 22 and the sacrificial layer 20, which includes a material selected from the group consisting of a transparent metal oxide, an alkaline water-soluble polymer compound, and an acid water-soluble polymer compound, are formed on the substrate 10, thereby preparing the carrier substrate 100. The substrate 10 includes a material allowing a laser beam to pass therethrough. For example, the substrate 10 may include at least one selected from the group consisting of E2K, borosilicate glass, fused silica glass, sapphire, and quartz.

The sacrificial layer 20 may include a transparent metal oxide, an alkaline water-soluble polymer compound, or an acid water-soluble polymer compound. The sacrificial layer 20 may be formed through a plasma enhanced chemical vapor deposition (PECVD) method, a sputtering method, a sol-gel coating method, a spray coating method, or a dipping coating method. The sacrificial layer 20 may have a thickness of about 200 nm or less. If the thickness of the sacrificial layer 20 exceeds about 200 nm, the sacrificial layer 20 may remain without being delaminated by an irradiated laser beam, so that the failure of the display apparatus may occur. In this regard, the sacrificial layer 20 preferably has the thickness of about 200 nm or less.

The adhesive layer 22 may include a polymer material such as polyimide or photoresist that can be delaminated by a laser beam. The adhesive layer 22 preferably has a thickness in the range of about 20 nm to about 50 nm. Such an adhesive layer 22 serves as an adhesive agent to bond the carrier substrate 100 to a flexible substrate 30 (see FIG. 3B) while protecting the sacrificial layer 20.

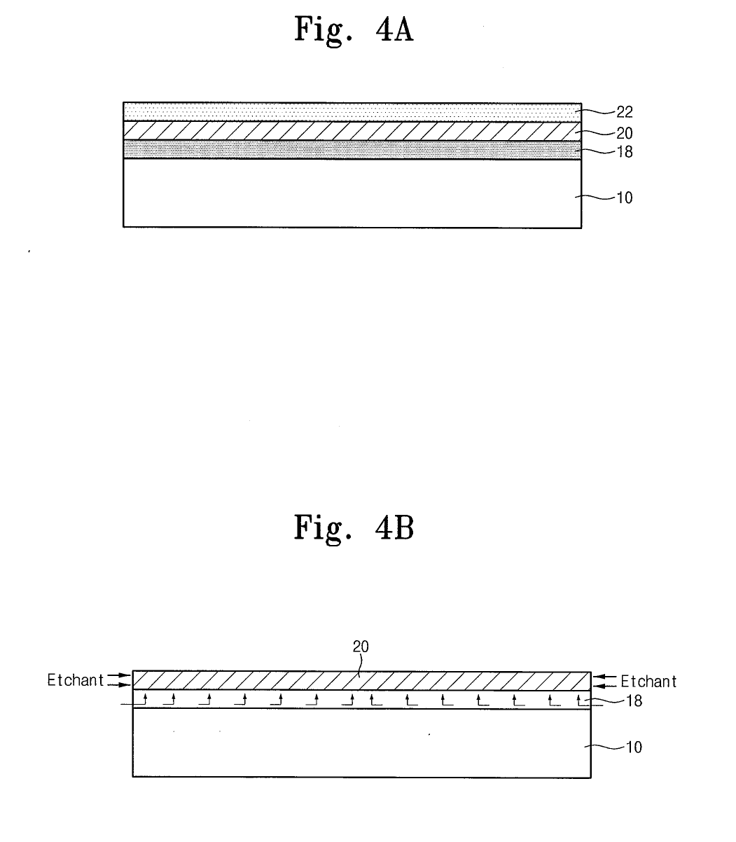

As shown in FIG. 4A, the carrier substrate 100 according to the second embodiment of the present invention may further include the etching promoter 18 under the sacrificial layer 20. Although the etching promoter 18 may include a porous material or a polymer material allowing gelation and having a swelling property, the present invention is not limited thereto. Accordingly, various materials of fast absorbing an etching solution (etchant) may be used for the etching promoter 18.

Referring to FIG. 3B, the flexible substrate 30 is formed on the carrier substrate 100. The flexible substrate 30 may be formed through a lamination scheme using a roller 32. The flexible substrate 30 preferably includes a polymer material selected from the group consisting of kapton, polyethersulphone (PES), and polyethylenenaphthalate (PEN), polyarylate (PAR).

Referring to FIG. 3C, the array of thin film transistors is formed on the flexible substrate 30. The array of the thin film transistors includes gate lines, data lines, thin film transistors adjacent to the cross part of the gate lines and the data lines, and a first electrode formed in a pixel area defined by the cross part.

The thin film transistor applies a data voltage supplied from the data line to the first electrode in response to a scan signal applied from the gate line. To this end, the thin film transistor includes a gate electrode, a source electrode, a drain electrode, an active layer, and an ohmic contact layer.

The first electrode generates a potential difference with a second electrode formed on an opposite substrate 60 (see FIG. 3D) by charging a voltage according to the data voltage applied from the thin film transistor. A display layer 40 (see FIG. 3D) interposed between the flexible substrate 30 and the opposite substrate 60 (see FIG. 3D) is driven due to the potential difference to display an image.

When the thin film transistor is manufactured, heat may occur. However, since kapton, PES, PEN, and PAR of the flexible substrate 30 have a small thermal coefficient expansion, the flexible substrate 30 may not be shrunken or bent due to the heat. Accordingly, the electric characteristic and the reliability of the thin film transistor may be improved.

Referring to FIG. 3D, the display layer 40 and the opposite substrate 60 are formed on the flexible substrate 30. The display layer 40 may include an electrophoresis film. The electrophoresis film includes a micro-capsule, which is formed by using a transparent thin film, and charged pigment particles of black and white contained in the micro-capsule and charged with cation and anion. When the micro-capsule is subject to an electric field, which is generated due to a potential difference between both ends of two opposite electrodes, the black particles and the white particles move toward the electrodes in the micro-capsule, in which the polarity of the particles is opposite to the polarity of the electrodes. At this time, the charged pigment particles reflect light input from an exterior, so that the micro-capsule displays an image having a black color or a white color.

The opposite substrate 60 includes the second electrode, and protects the micro-capsule from an external shock. The opposite substrate 60 includes a transparent material such that an image displayed based on the charged pigment particles is recognized by a user. For example, the opposite substrate 60 preferably has the form of a film employing a plastic material or a glass material.

The second electrode is formed at the upper portion of the electrophoresis film to face the first electrode. Similarly to the opposite substrate 60, the second electrode includes a transparent material to transmit an incident light. For example, the second electrode preferably includes ITO or IZO. Such a second electrode applies an electric field to the charged pigment particles of the micro-capsule. In order to display an image, the second electrode controls black particles and white particles to form an electric field in cooperation with the first electrode.

Referring to FIGS. 3E and 3F, the carrier substrate 100 is delaminated by irradiating a laser beam or a light source onto the adhesive layer 22, thereby obtaining a flexible display apparatus 200. For example, an excimer laser beam has energy to decompose polymer. Accordingly, when the excimer laser beam is irradiated onto the surface of plastic, the surface of the plastic may be thinned through adjustment of an amount of irradiated laser beam and irradiation time of the laser beam. Thus, when the excimer laser beam is irradiated onto the carrier substrate 100, energy transmitting the substrate 10 decomposes the adhesive layer 22 including a polymer material to separate the carrier substrate 100 from the flexible display substrate 200.

Referring to FIGS. 3G and 3H, the sacrificial layer 20 is removed from the substrate 10, so that the substrate 10 may be recycled.

The sacrificial layer 20 may be removed by using an etchant. However, if the sacrificial layer 20 includes polyacrylate, the sacrificial layer 20 may be removed by using an organic solvent such as dichloromethanen or chloroform, or piranha cleaner.

When the etching promoter 18 is further provided under the sacrificial layer 20, etchant is absorbed into the etching promoter 18 as shown in FIG. 4B. Since the etching promoter 18 includes a porous material having a plurality holes such that the etchant can be introduced into the etching promoter 18, the etching promoter 18 easily absorbs the etchant. An etching promoter 18 that includes a polymer material allowing gelation and representing a swelling property does not have a plurality of pores because the etching promoter 18 has molecular density higher than that of a polymer compound of a porous material. As such, the etching promoter 18 has absorbing power for the etchant that is higher than that of other materials by about 100 times or about 200 times. Accordingly, since the entire lower portion of the sacrificial layer 20 is exposed to the etchant through the etching promoter 18 including a material allowing gelation and having a swelling property or the porous material, the sacrificial layer 20 may be efficiently removed within a shorter time as compared to lateral etching performed without the etching promoter 18.

According to the above, the carrier substrate including the sacrificial layer and the adhesive layer may be recycled, thereby reducing a manufacturing cost.

Although the electrophoresis display apparatus is described as one example according to the present embodiment, the present invention is not limited thereto, but applicable for various display apparatuses.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A carrier substrate comprising:
a rigid substrate;
an adhesive layer formed on the rigid substrate and having an adhesive property; and
a sacrificial layer interposed between the rigid substrate and the adhesive layer, the sacrificial layer comprising a material selected from the group consisting of a transparent metal oxide, an alkaline water-soluble polymer compound, and an acid water-soluble polymer compound.

2. The carrier substrate of claim 1, wherein the rigid substrate comprises at least one glass material selected from the group consisting of E2K, borosilicate glass, fused silica glass, sapphire, and quartz.

3. The carrier substrate of claim 1, wherein the transparent metal oxide comprises at least one selected from the group consisting of indium tin oxide, indium zinc oxide, and zinc oxide.

4. The carrier substrate of claim 1, wherein the alkaline water-soluble polymer compound comprises at least one selected from the group consisting of polyacrylic acid, co-polymer containing polyacrylic acid, polystyrene, co-polymer containing polystyrene, polysulfate, co-polymer containing polysulfate, polyamic acid, and co-polymer containing polyamic acid.

5. The carrier substrate of claim 1, wherein the acid water-soluble polymer compound comprises at least one selected from the group consisting of polyamine, co-polymer containing polyamine, polyvinylalcohol (PVA), co-polymer containing PVA, polyallyamine, and polyacrylic acid.

6. The carrier substrate of claim 1, wherein the sacrificial layer has a thickness of about 200 nm or less.

7. The carrier substrate of claim 1, wherein the adhesive layer comprises polyimide or photoresist which is removed through irradiation of a laser beam.

8. The carrier substrate of claim 7, wherein the adhesive layer has a thickness of about 20 nm to about 50 nm.

9. The carrier substrate of claim 1, further comprising an etching promoter on at least one surface of the sacrificial layer.

10. The carrier substrate of claim 9, wherein the etching promoter comprises a porous material or a material enabling gelation and having a swelling property.

11. A method of manufacturing a flexible display apparatus, the method comprising:
forming a sacrificial layer on a rigid substrate;
forming an adhesive layer on the sacrificial layer to prepare a carrier substrate;
laminating a flexible substrate on the carrier substrate;
forming a display layer and an opposite substrate on the flexible substrate;
irradiating a laser beam on the adhesive layer to delaminate the carrier substrate; and
removing the sacrificial layer.

12. The method of claim 11, wherein the rigid substrate comprises at least one glass material selected from the group consisting of E2K, borosilicate glass, fused silica glass, sapphire, and quartz.

13. The method of claim 11, wherein the sacrificial layer has a thickness of about 200 nm or less.

14. The method of claim 11, wherein the adhesive layer comprises polyimide or photoresist which is removed through irradiation of a laser beam.

15. The method of claim 14, wherein the adhesive layer has a thickness of about 20 nm to about 50 nm.

16. The method of claim 11, wherein the sacrificial layer is removed by an etchant.

17. The method of claim 11, further comprising an etching promoter on at least one surface of the sacrificial layer.

18. The method of claim 17, wherein the etching promoter comprises a porous material or a material enabling gelation and having a swelling property.

19. The method of claim 11, wherein the sacrificial layer comprises a material selected from the group consisting of a transparent metal oxide, an alkaline water-soluble polymer compound, and an acid water-soluble polymer compound.
